(19) United States
(12) Patent Application Publication
(10) Pub. No.: US 2022/0284288 A1
(43) Pub. Date: Sep. 8, 2022

(54) LEARNING FROM BIOLOGICAL SYSTEMS HOW TO REGULARIZE MACHINE-LEARNING

(71) Applicants: BAYLOR COLLEGE OF MEDICINE, HOUSTON, TX (US); UNIVERSITY OF TUBINGEN, TUBINGEN (DE)

(72) Inventors: ANDREAS TOLIAS, HOUSTON, TX (US); ZHE LI, HOUSTON, TX (US); ZACHARY PITKOW, HOUSTON, TX (US); JOSUE ORTEGA CARO, HOUSTON, TX (US); ANKIT PATEL, HOUSTON, TX (US); JACOB REIMER, HOUSTON, TX (US); MATTHIAS BETHGE, TUBINGEN (DE); FABIAN SINZ, TUBINGEN (DE)

(73) Assignees: BAYLOR COLLEGE OF MEDICINE, HOUSTON, TX (US); UNIVERSITY OF TUBINGEN, TUBINGEN (DE)

(21) Appl. No.: 17/641,259

(22) PCT Filed: Sep. 24, 2020
(86) PCT No.: PCT/US2020/052538

§ 371 Date: Mar. 8, 2022

Related U.S. Application Data
(60) Provisional application No. 62/905,287, filed on Sep. 24, 2019.

(51) Int. Cl. G06N 3/08

(52) U.S. Cl. CPC G06N 3/08

(57) ABSTRACT

The present disclosure relates to machine-learning generalization, and in particular to techniques for regularizing machine-learning The present disclosure relates to machine-learning generalization, and in particular to techniques for regularizing machine-learning models using biological systems (e.g. brain data) to engineer machine-learning-algorithms that can generalize better. Particularly, aspects are directed to a computer implemented method that includes measuring a plurality of biological responses (e.g. neural responses to stimuli or other variables such body movements); generating data (e.g. responses to stimuli) using the predictive model which can denoise biological data and extract task relevant information; scaling and transforming these predictions (e.g. measure representational similarities between stimuli); and using the biologically derived data to regularize machine-learning-algorithms. The method is applicable in many domains of computer science and artificial intelligence such as perception, learning, memory, cognition, decision making.

### PRIORITY CLAIM

The present application claims priority and benefit from U.S. Provisional Application No. 62/905,287, filed on Sep. 24, 2019, the contents of which are incorporated herein by reference in their entirety for all purposes.

### STATEMENT OF GOVERNMENT SUPPORT

The invention was made with government support under Grant No. D16PC00003 awarded by the Intelligence Advanced Research Projects Activity. The government has certain rights in the invention.

### FIELD

The present disclosure relates to machine-learning generalization, and in particular to techniques (e.g., systems, methods, computer program products storing code or instructions executable by one or more processors) for regularizing machine-learning models using biological systems.

### BACKGROUND

The brain is an intricate system, distinguished by its ability to learn to perform complex computations underlying perception, cognition and motor control defining features of intelligent behavior. For decades, scientists have attempted to mimic its abilities in artificial intelligence (AI) systems. These attempts had limited success until recent years when successful AI applications have come to pervade many aspects of our everyday life. Machine learning algorithms can now recognize objects and speech, and have mastered games like Chess and Go, even surpassing human performance (i.e., DeepMind's AlphaGo Zero). AI systems promise an even more significant change to come: improving medical diagnoses, finding new cures for diseases, making scientific discoveries, predicting financial markets and geopolitical trends, and identifying useful patterns in many other kinds of data.

Our perception of what constitutes intelligent behavior and how we measure it has shifted over the years as tasks that were considered hallmarks of human intelligence were solved by computers while tasks that appear to be trivial for humans and animals alike remained unsolved. Classical symbolic AI focused on reasoning with rules defined by experts, with little or no learning involved. The rule-based system of Deep Blue, which defeated Kasparov in 1997 in chess, was entirely determined by the team of experts who programmed it. Unfortunately, it did not generalize well to other tasks. This failure and the challenge of artificial intelligence even today is summarized in Moravec's paradox (Moravec, H., 1988. Mind children: The future of robot and human intelligence. Harvard University Press): “it is comparatively easy to make computers exhibit adult level performance on intelligence tests or playing checkers, and difficult or impossible to give them the skills of a one-year-old when it comes to perception and mobility.” While rules in symbolic Al provide a lot of structure for generalization in very narrowly defined tasks, we find ourselves unable to define rules for everyday tasks—tasks that seem trivial because biological intelligence performs so effortlessly well.

The renaissance of artificial intelligence is a result of a major shift of methods from classical symbolic AI to connectionist models used by machine learning. The critical difference from rule-based AI is that connectionist models are “trained,” not “programmed.” Searching through the space of possible combinations of rules in symbolic AI is replaced by adapting parameters of a flexible nonlinear function using optimization of an objective (goal) that depends on data. In artificial neuronal networks, this optimization is usually implemented by backpropagation. A considerable amount of effort in machine learning is being devoted to figuring out how this training can be done most effectively, as judged by how well the learned concepts generalize and how many data points are needed to robustly learn a new concept (“sample complexity”).

The current state of the art methods in machine learning are dominated by deep learning: multi-layer (deep) artificial neural networks (DNNs), which draw inspiration from the brain. With the help of deep networks, it is now possible to solve some perceptual tasks that are simple for humans but used to be very challenging for artificial intelligence. The so-called ImageNet benchmark, a classification task with one thousand categories on photographic images downloaded from the internet, played an important role in demonstrating this. Besides solving this particular task at human level performance, it also turned out that pre-training deep networks on ImageNet can often be surprisingly beneficial for all kinds of other tasks. In this approach, called transfer learning, a network trained on one task, such as object recognition, is reused in another task by removing the task-specific part (layers high up in the hierarchy) and keeping the nonlinear features computed by the hidden layers of the network. This makes it possible to solve tasks with complex deep networks that usually would not have had enough training data to train the network de novo. In many computer vision tasks, this approach works much better than hand-crafted features which used to be state-of-the-art for decades. In saliency prediction, for example, the use of pretrained features has led to a dramatic improvement of the state of-the-art. Similarly, transfer learning has proven extremely useful in behavioral tracking of animals: using a pre-trained network and a small number of training images (˜200) for tine tuning enables the resulting network to perform very close to human-level labeling accuracy.

Flexible learning based methods so far have always outperformed hand-crafted domain knowledge in the long run. Search based methods of deep learning beat strategies attempting a deeper analytic understanding, and deep neuronal networks consistently outperform hand-crafted features used for decades in computer vision. However, flexibility alone cannot be the silver bullet. Without the right (implicit) assumptions, generalization is impossible. While the success of deep networks on narrowly defined perceptual tasks is a major leap forward, the range of generalization of these networks is still limited. The major challenge in building the next generation of intelligent systems is to find sources for good implicit biases that will allow for strong generalization across varying data distributions and rapid learning of new tasks without forgetting previous ones. These biases will need to be problem domain specific. Accordingly, the need exists for techniques for improving machine learning generalization.

### BRIEF SUMMARY

In various embodiments, a computer-implemented method is provided. The method includes accessing, by a computing system, a plurality of stimuli for a stimulus scheme; inputting, by the computing system, a first stimulus of the plurality of stimuli into a neural predictive model; generating, by the neural predictive model, a prediction of a first neural response of a biological system to the first stimulus; scaling, by the neural predictive model, the predicted first neural response with a signal-to-noise weight to generate a denoised predicted first neural response; and providing, by the computing system, the denoised predicted first neural response.

Optional the method may further include repeating the inputting of the first stimulus to generate, by the neural predictive model, a plurality of denoised predicted first neural responses for the first stimulus; and generating, by the neural predictive model, a denoised population first neural response based on the plurality of denoised predicted first neural responses, where the denoised population first neural response is a vector of the plurality of denoised predicted first neural responses for the first stimulus.

Optional the method may further include inputting, by the computing system, a second stimulus of the plurality of stimuli into the neural predictive model; generating, by the neural predictive model, a prediction of a second neural response of the biological system to the second stimulus; scaling, by the neural predictive model, the predicted second neural response with the signal-to-noise weight to generate a denoised predicted second neural response; repeating the inputting of the second stimulus to generate, by the neural predictive model, a plurality of denoised predicted second neural responses for the second stimulus; and generating, by the neural predictive model, a denoised population second neural response based on the plurality of denoised predicted second neural responses, where the denoised population second neural response is a vector of plurality of denoised predicted second neural responses for the second stimulus.

Optionally the method may further include shifting and normalizing, by the neural predictive model, the denoised population first neural response and the denoised population second neural response to create a centered unit vector for each of the denoised population first neural response and the denoised population second neural response; and constructing a similarity matrix using the centered unit vector for each of the demised population first neural response and the denoised population second neural response based on a representation similarity metric.

In other embodiments, a computer-implemented method is provided. The method includes: accessing a plurality of data for a task scheme; inputting data of the plurality of data into a task predictive model, where the task predictive model is jointly trained to both classify the data and predict a neural similarity; generating, by the task predictive model, a prediction of a task based on the classification of the data and the predicted neural similarity, where the generating comprises application of a loss function that includes task based loss and a neural based loss, and where the neural based loss favors biological system representations using the predicted neural similarity; and providing the prediction of the task.

In other embodiments, a computer-implemented method is provided. The method includes: accessing, by a computing system, a plurality of stimuli for a behavioral scheme; inputting, by the computing system, a first stimulus of the plurality of stimuli into a behavioral predictive model; generating, by the behavioral predictive model, a prediction of a first behavioral response of a biological system to the first stimulus; scaling, by the behavioral predictive model, the predicted first behavioral response with a signal-to-noise weight to generate a predicted first behavioral response; and providing, by the computing system, the predicted first behavioral response.

Optionally, the signal-to-noise weight (w_{α})=(signal strength σ²_{α})/noise strength η²_{α}), where α is a given behavioral component of the biological system.

Optionally, the scaled predicted first behavioral response is defined as r\hat{ }_{αi}=w_{α}ν_{α}p\hat{ }_{αi}, where (w_{α})=(signal strength σ²_{α})/(noise strength η²_{α}), α is a given behavioral component of the biological system and i is the first stimulus, and v_{α} is a correlation between an actual behavioral response of the biological system to the first stimulus and the predicted first behavioral response of the biological system.

Optionally, the behavioral predictive model is a convolutional neural network, the plurality of stimuli are a plurality of stimuli, triggers, and/or behavioral requests, and the first stimulus is a first behavioral request.

In some embodiments, the method further comprises: repeating the inputting of the first stimulus to generate, by the behavior predictive model, a plurality of predicted first behavioral responses for the first stimulus; and generating, by the behavioral predictive model, a multi-system first behavioral response based on the plurality of predicted first behavioral responses, where the multi-system first behavioral response is a vector of the plurality of multi-system predicted first behavioral responses for the first stimulus.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein.

Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims

### BRIEF DESCRIPTION OF THE DRAWINGS

The present invention will be better understood in view of the following non-limiting figures, in which:

FIG. 1 shows an example computing environment for regularizing machine-learning models using biological systems in accordance with various embodiments;

FIG. 2 shows an exemplary schematic diagram representative of a neural predictive model architecture in accordance with various embodiments;

FIG. 3 shows techniques for denoising neural responses using a neural predictive model in accordance with various embodiments;

FIG. 4 shows techniques for predicting neural similarity or a similarity matrix for neural responses in accordance with various embodiments;

FIG. 5 shows an exemplary schematic diagram representative of a behavioral predictive model architecture in accordance with various embodiments;

FIG. 6 shows techniques for predicting behavioral responses using a behavioral predictive model in accordance with various embodiments;

FIG. 7 shows an exemplary schematic diagram representative of a task predictive model architecture in accordance with various embodiments;

FIG. 8 show techniques for neural regularization of a predictive model in accordance with various embodiments;

FIGS. 9A-9D show representation similarity in neural data and predictive models in accordance with various embodiments;

FIG. 10 shows examples of similar and dissimilar image pairs in accordance with various embodiments;

FIG. 11 shows a joint training schematic in accordance with various embodiments;

FIG. 12 shows performance robustness to Gaussian noise in accordance with various embodiments; and

FIG. 13 shows adversarial robustness of classifier networks in accordance with various embodiments.

### DETAILED DESCRIPTION

### I. Introduction

The present disclosure describes techniques for regularizing machine-learning models using biological systems. More specifically, some embodiments of the present disclosure provide techniques (e.g., systems, methods, computer program products storing code or instructions executable by one or more processors) for regularizing predictive models (e.g., convolutional neural networks (CNNs) for artificial intelligence (AI) tasks and machine learning (ML) problems in general) using large-scale neuroscience data to learn more robust neural features in terms of representational similarity. Regularizing is a technique used to improve the generalization of predictive models by adding a function appropriately to the optimization objective on the given training set (i.e., introduction of a bias that helps generalization).

Predictive models such as CNNs are widely used in computer vision tasks, and can achieve super-human performance on many classification tasks. However, there is a still huge gap between these models and the human visual system in terms of robustness and generalization. Understanding why a biological system such as the visual system has superior performance on so many problems including perceptual problems is one of the central questions of neuroscience and machine learning. In particular, predictive models are vulnerable to adversarial attacks and noise distortions while human perception is barely affected by these small perturbations. This highlights that state-of-the-art predictive models (e.g., DNN) lack human level understanding and do not rely on the same causal features as humans for understanding (e.g., visual perception). Regularization and implicit inductive biases in deep networks can positively affect robustness and generalization by constraining the parameter space and biasing the trained model to use better features. However, the biases used in DNNs are often rather nonspecific and networks often latch onto patterns that do not generalize well outside the distribution of training data. In contrast to deep networks, biological systems (e.g., biological visual systems) cope with strongly varying conditions all the time.

To address these limitations and problems, and others, various embodiments are directed to techniques for biasing predictive models towards biological systems in order to improve robustness of the predictive models. More specifically, some embodiments are directed to measuring a neural representation in a biological system (e.g., animal visual cortices) and biasing a predictive model towards a more biological feature space, which ultimately leads to a more robust predictive model. For example, one illustrative embodiment of the present disclosure comprises recording the simultaneous responses of thousands of neurons to a stimulus (e.g., complex natural scenes) in a biological system (e.g., a visual cortex of awake mice); and modifying the objective function of a predictive model (e.g., a CNN) so that convolutional features are encouraged to establish the same structure as neural activities in order to bias the predictive model towards biological feature representations. Advantageously, these techniques provide for trained predictive models that have a higher classification accuracy than baseline when input images were corrupted by random noise or adversarial perturbations.

### II. Techniques for Biasing Predictive Models Towards Biological Stimulus

Described herein are techniques to regularize one or more task predictive models (e.g., models trained image classification to perform a visual task) using large-scale neuroscience data to learn more robust neural features in terms of representational similarity. In various embodiments, a stimulus such as natural images is presented to a biological system (e.g., the visual system of a mouse through the eyes) and the responses of thousands of neurons to the stimulus are measured from the biological system (e.g., the visual system of a mouse including the cortical visual areas). Thereafter, the variable neural activity of the biological system is denoised using one or more neural predictive models trained on the large corpus of responses from the biological system, and a representational similarity is calculated for a number of pairs of stimulus (e.g., millions of pairs of images) from the model's predictions. In some embodiments, the neural representation similarity is used to regularize one or more tasks of the predictive models (e.g. CNN predicting object class of an image) by penalizing intermediate representations that deviated from neural ones. Advantageously, this preserves performance of baseline models when classifying input data (e.g., images) under standard benchmarks, while maintaining substantially higher performance compared to baseline or control models when classifying noisy input data. Moreover, the models regularized with cortical representations also improved model robustness in terms of adversarial attacks. This demonstrates that regularizing with neural data can be an effective tool to create an inductive bias towards more robust inference.

### Example Computing Environment

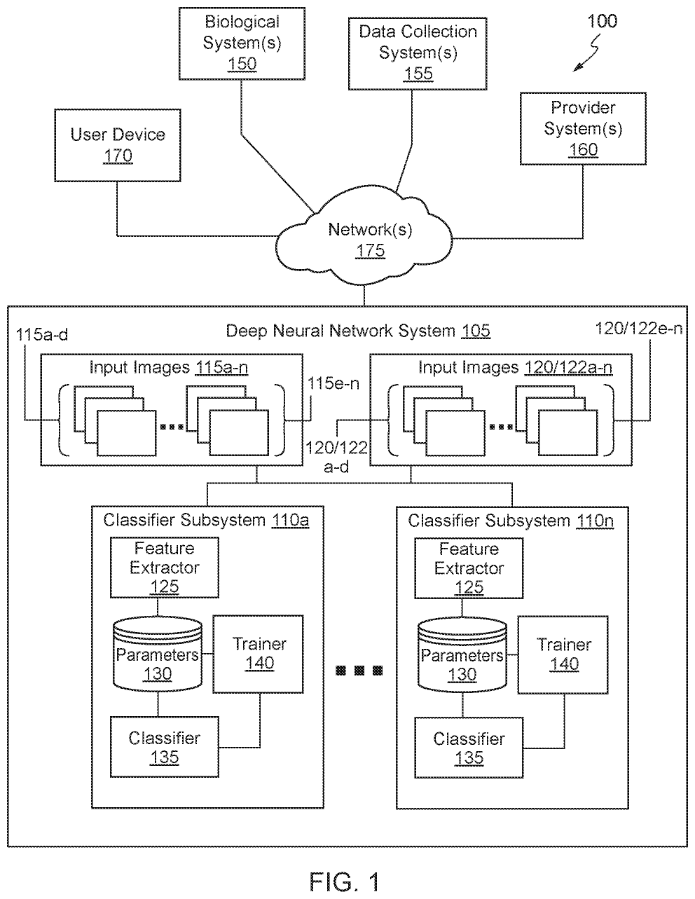

FIG. 1 illustrates an example computing environment 100 for biasing predictive models towards biological system's computation (e.g. representational similarity) using one or more predictive models deep convolutional neural networks) according to various embodiments. The computing environment 100 includes a DNN system 105 to train and execute one or more neural predictive models, one or more behavioral predictive models, one or more task predictive models, or a combination thereof. More specifically, the DNN system 105 includes classifier subsystems 110a-n that can train their respective predictive models (e.g., CNNs). In some embodiments, each neural predictive model corresponding to subsystems 110a-n is separately trained based on neural data such as responses to images within a set of input elements 115a-n. In some instances, behavioral data of a biological system used to collect neural responses to the neural stimuli such as the pupil position and size, as well as the running speed on the treadmill are also input to the neural predictive model to account for the effect of non-stimuli variables. The input elements 115a-n can include one or more training input elements 115a-d, testing or validation input elements 115e-g, and unlabeled input elements 115h-n. It will be appreciated that input elements corresponding to the training, validation and testing need not be accessed at a same time. For example, initial training and validation input elements may first be accessed and used to train a model, and unlabeled or testing input elements may be subsequently accessed or received (e.g., at a single or multiple subsequent times).

In some embodiments, each behavioral model corresponding to subsystems 110a-n is separately trained based on behavioral data such as behavior of a subject performing a task (e.g., the actions and mannerisms made by individuals, organisms, systems or artificial entities in conjunction with themselves or their environment, which includes the other systems or organisms around as well as the physical environment while performing a task such as object recognition or answering email) within a set of input elements 120a-n. In some instances, neural data such as responses to stimuli while performing a task are also input to the behavioral predictive model. The input elements 120a-n can include one or more training input elements 120a-d, testing or validation input elements 120e-g, and unlabeled input elements 120h-n. It will be appreciated that input elements corresponding to the training, validation and testing need not be accessed at a same time. For example, initial training and validation input elements may first be accessed and used to train a model, and unlabeled or testing input elements may be subsequently accessed or received (e.g., at a single or multiple subsequent times).

In some embodiments, each task predictive model (i.e., AI or ML model for a task such as object recognition) corresponding to the classifier subsystems 110a-n is separately trained based on task data for a given task such as images for classification within a set of input elements 122a-n. In some instances, contextual data of a data system used to collect the task data such as time stamps, weather, lighting conditions, as well as mechanical parameters such as camera type and shutter speed, are also input to the task predictive model to account for the effect of non-task data variables. The input elements 122a-n can include one or more training input elements 122a-d, testing or validation input elements 122e-g, and unlabeled input elements 122h-n. It will be appreciated that input elements corresponding to the training, validation and testing need not be accessed at a same time. For example, initial training and testing input elements may first be accessed and used to train a model, and unlabeled input elements may be subsequently accessed or received (e.g., at a single or multiple subsequent times) during neural stimuli prediction or task implementation.

In some embodiments, the predictive models are trained using the training input elements 115a-d, 120a-d, or 122a-d (and the testing input elements 115e-g, 120e-g, or 122e-g to monitor training progress), a loss function and/or a gradient descent method. The training process for the predictive models includes selecting hyperparameters for the predictive models and performing iterative operations of inputting the training input elements 115a-d, 120a-d, or 122a-d (and the testing input elements 115e-g, 120e-g, or 122e-g to monitor training progress) into the predictive models to find a set of model parameters e.g., weights and/or biases) that minimizes a loss or error function for the predictive models. The hyperparameters are settings that can be tuned or optimized to control the behavior of the predictive models. Most models explicitly define hyperparameters that control different aspects of the models such as memory or cost of execution. However, additional hyperparameters may be defined to adapt a model to a specific scenario. For example, the hyperparameters may include the number of hidden units of a model, the learning rate of a model, the convolution kernel width, or the number of kernels for a model.

Each iteration of training can involve finding a set of model parameters for the predictive models (configured with a defined set of hyperparameters) so that the value of the loss or error function using the set of model parameters is smaller than the value of the loss or error function using a different set of model parameters in a previous iteration. The loss or error function can be constructed to measure the difference between the outputs inferred using the predictive models (in some instances, the neural responses, behavioral responses, or tasks) and the ground truth. In certain instances, the predictive models can be trained using supervised training, and each of the training input elements 115a-d, 120a-d, or 122a-d and the validation input elements 115e-g, 120e-g, or 122e-g can be associated with one or more labels that identify a “correct” interpretation of the neural stimuli, behavioral data, or task data. Labels may alternatively or additionally be used to classify a corresponding input element, or subcomponent of the input element (e.g., a pixel or voxel therein). In certain instances, the predictive models can be trained using unsupervised training, and each of the training input elements 115a-d, 120a-d, or 122a-d and the testing input elements 115e-g, 120e-g, or 122e-g need not be associated with one or more labels. Each of the unlabeled elements 115h-n, 20h-n, or 122h-n need not be associated with one or more labels.

In some embodiments, the classifier subsystems 110a-n include a feature extractor 125, a parameter data store 130, a classifier and/or regressor 135, and a trainer 140, which are collectively used to train the predictive models based on training data (e.g., the training input elements 115a-d, 120a-d, or 122a-d) and optimizing the parameters of the predictive models during supervised training, unsupervised training, or a combination thereof. In some embodiments, the classifier subsystem 110a-n accesses training data from the training input elements 115a-d, 120a-d, or 122a-d at the input layers. The feature extractor 125 may pre-process the training data to extract relevant features (e.g., edges) detected at particular parts of the training input elements 115a-d, 120a-d, or 122a-d. The classifier and/or regressor 135 can receive the extracted features and transform the features, in accordance with weights associated with a set of hidden layers in one or more predictive models, into one or more outputs such as a predicted neural response, predicted behavioral response, or image classification. The trainer 140 may use training data corresponding to the training input elements 115a-d, 120a-d, or 122a-d to train the feature extractor 125 and/or the classifier and/or regressor 135 by facilitating learning one or more parameters. For example, the trainer 140 can use a backpropagation technique to facilitate learning of weights associated with a set of hidden layers of the predictive model used by the classifier and/or regressor 135. The backpropagation may use, for example, a stochastic gradient descent (SGD) algorithm to cumulatively update the parameters of the hidden layers. Learned parameters may include, for instance, weights, biases, and/or other hidden layer-related parameters, which can be stored in the parameter data store 130.

An ensemble of trained predictive models can be deployed to process unlabeled input elements 115h-n and/or 120h-n to predict neural stimuli and/or implement a task such as image classification. More specifically, a trained version of the feature extractor 125 may generate a feature representation of an unlabeled input element, which can then be processed by a trained version of the classifier and/or regressor 135. In some embodiments, data features can be extracted from the unlabeled input elements 115h-n, 120h-n, and/or 122h-n based on one or more blocks, layers, convolutional blocks, convolutional layers, residual blocks, pyramidal layers, or the like that leverage dilation of the predictive models in the classifier subsystems 110a-n. The features can be organized in a feature representation, such as a feature vector of the input data. The predictive models can be trained to learn the feature types based on classification and subsequent adjustment of parameters in the hidden layers, including a fully connected layer of the predictive models. In some embodiments, the data features extracted by the blocks, layers, convolutional blocks, convolutional layers, residual blocks, pyramidal layers, or the like include feature maps that are matrices of values that represent one or more portions of the data at which one or more pre-processing operations have been performed (e.g., edge detection, sharpen image resolution, etc.). These feature maps may be flattened for processing by a fully connected layer of the predictive models, which outputs a predicted neural response or prediction for a given task.

For example, an input element can be fed to an input layer of a predictive model. The input layer can include nodes that correspond with specific components of the neural stimuli or task data, for example, pixels or voxels. A first hidden layer can include a set of hidden nodes, each of which is connected to multiple input-layer nodes. Nodes in subsequent hidden layers can similarly be configured to receive information corresponding to multiple components of the data. Thus, hidden layers can be configured to learn to detect features extending across multiple components. Each of the one or more hidden layers can include a block, a layer, a convolutional block, a convolutional layer, a residual block, a pyramidal layer, or the like including adding complexity in the network architecture to mimic the brain (e.g., cell types, lateral and feedback recurrent connections, gating for attention). The predictive model can further include one or more fully connected layers (e.g., a softmax layer).

At least part of the training input elements 115a-d, 120a-d, or 122a-d, the validation input elements 115e-g, 120e-g, or 122e-g and/or the unlabeled input elements 115h-n, 120h-n, or 120h-n may include or may have been derived from data collected using and received from one or more biological systems 150 (e.g., the visual system of a mouse other sensory systems, animals or humans performing cognitive and/or physical tasks such as memory, learning, decision making and motor behaviors) and/or one or more data collection systems 155 (e.g., an image collection system such as a camera). The biological system 150 can be connected to a stimulus providing system configured to stimulate the biological system with one or more stimuli and a stimulus response detection system configured to collect neural response data (e.g., response of individual or sets of neurons to a stimulus such as an image with recording technologies such as but not limited to imaging technologies [multi-photon imaging, fMRI] and electrophysiological [i.e. intracortical, subdural or non-invasive methods such as EEG from both animals and humans]). In some instances, the stimulus providing system can include a means for providing a stimulation (e.g., a display to show images or an electrode to deliver current to a tissue or other methods to manipulate activity such as optogenetic methods). The stimuli such as images may be obtained from the data collection systems 155. In some instances, the stimulus response detection system includes an imaging device to obtain scans of the biological system that visually illustrate the neural response to the stimulus, e.g., 2-photon scans in primary visual cortex of mice or EEG and single-cell recordings in humans. The data collection systems 155 may include one or more data collection devices, for example, sensors for capturing sensed data or image capture devices for capturing image data such as cameras, computing devices, memory devices, magnetic resonance imaging device, or the like configured to obtain neural stimuli for the stimulus providing system or task data for performing a defined task.

Additionally or alternatively, the biological system 150 can be connected to a behavior system configured to elicit the biological system with one or more stimuli, triggers, and/or requests and a behavior response detection system configured to collect cognitive and physical behavior response data (e.g., behavioral response of individual to stimuli, triggers, and/or requests including but not limited to speech, somatic nervous system responses such as body movement and skeletal muscle contraction/relaxation, autonomic nervous system responses such as breathing and heartbeat, biochemical changes within the subject such as release of adrenaline, resulting physical actions taken by the subject such as typing, running, standing, etc.). In some instances, the behavior system can include a means for providing one or more stimuli, triggers, and/or requests (e.g., a quiz, a request for an action or performance of a task such as answering an email or solving a puzzle). The stimuli, triggers, and/or requests such as task requests may be obtained from the data collection systems 155. In some instances, the behavior response detection system includes an auditory and imaging device to obtain recordings of the biological system that audibly and visually illustrate the behavioral response to the stimulus, e.g., microphone, camera, and/or video recordings. The data collection systems 155 may include one or more data collection devices, for example, sensors for capturing sensed data or image capture devices for capturing image data such as cameras, computing devices, memory devices, magnetic resonance imaging device, or the like configured to obtain neural stimuli for the stimulus providing system or task data for performing the defined task

In some instances, labels associated with the training input elements 115a-d, 120a-d, or 122a-d and/or testing input elements 115e-g, 120e-g, or 122e-g may have been received or may be derived from data received from one or more provider systems 160, each of which may be associated with (for example) a physician, nurse, hospital, pharmacist, research facility, etc. associated with a particular test subject. The received data may include (for example) one or more medical records corresponding to the particular subject. The medical records may indicate (for example) a professional's diagnosis or characterization that indicates, with respect to a time period corresponding to a time at which one or more input elements associated with the subject were collected or a subsequent defined time period, whether the subject had a disease and/or a stage of progression of the subject's disease (e.g., along a standard scale and/or by identifying a metric). The received data may further include a parameter of interest such as pixels or voxels of the locations of an object of interest within the one or more input elements associated with the stimuli or task. Thus, the medical records may include or may be used to identify, with respect to each training/validation input element, one or more labels. The medical records may further indicate each of one or more treatments (e.g., medications) that the subject had been taking and time periods during which the subject was receiving the treatment(s). In some instances, data input to one or more classifier subsystems are received from the provider system 160. For example, the provider system 160 may receive parameters for neural stimuli from the data collection system 155, comments on neural responses from the one or more biological systems 150, and/or task implantation or context data from the data collection system 155 and may then transmit the data (e.g., along with a subject identifier and one or more labels) to the DNN system 105. Although, the provider and data are described herein with respect to a medical setting it should be understood that the techniques described herein are applicable to other settings, e.g., autonomous driving or navigation.

In some embodiments, neural or behavioral stimuli, triggers, and/or requests from the data collection system 155, neural and behavioral responses from the one or more biological systems 150, and/or task data from the data collection system 155 may be aggregated with data received at or collected at one or more of the provider systems 160. For example, the DNN system 105 may identify corresponding or identical identifiers of a test subject, a task, and/or time period so as to associate neural or behavioral stimuli, triggers, and/or requests, neural and behavioral response data, and/or task data received from the biological systems 150 and/or the data collection system 155 with label data received from the provider system 160. The DNN system 105 may further use metadata or automated data analysis to process the neural or behavioral stimuli, triggers, and/or requests, neural and behavioral response data, or task data to determine to which classifier subsystem 110a-n particular data components are to be fed. For example, neural stimuli received from the data collection system 155 may correspond to one or more test subjects and may be input to a classifier subsystem 110a-n associated with a neural predictive model. Metadata, automated alignments and/or data processing may indicate, for each data element, its associated neural stimuli scheme, test subject, task, or the like. For example, automated alignments and/or data processing may include detecting whether a data element has image properties corresponding to a particular stimuli scheme or test subject. Label-related data received from the provider system 160 may be neural stimuli-specific, neural response-specific, task-specific, scheme-specific or subject-specific. When label-related data is task-specific or scheme-specific, metadata or automated data analysis (e.g., using natural language processing, image processing, or text analysis) can be used to identify to which task or scheme label-related data corresponds. When label-related data is neural stimuli-specific, neural response-specific, or subject-specific, identical label data (for a given response or subject) may be fed to each classifier subsystem during training.

In some embodiments, the computing environment 100 can further include a user device 170, which can be associated with a user that is requesting and/or coordinating performance of one or more iterations (e.g., with each iteration corresponding to one run of the model and/or one production of the model's output(s)) of the DNN system 105. The user may correspond to a physician, investigator (e.g., associated with a clinical trial), test subject, medical professional, etc. Thus, it will be appreciated that, in some instances, the provider system 160 may include arid/or serve as the user device 170. Each iteration may be associated with a particular test subject (e.g., person), who may (but need not) be different than the user. A request for the iteration may include and/or be accompanied with information about the particular subject or task (e.g., a name or other identifier of the subject or task, such as a de-identified patient identifier). A request for the iteration may include an identifier of one or more other systems from which to collect data, such as input image data that corresponds to a. neural stimuli scheme, the test subject, or a task. In some instances, a communication from the user device 170 includes an identifier of each of a set of particular neural stimuli schemes, test subjects, or tasks, in correspondence with a request to perform an iteration for each scheme, subject, or task represented in the set.

Upon receiving the request, the DNN system 105 can send a request (e.g., that includes an identifier of the scheme, subject, or task) for unlabeled input data elements to the one or more corresponding biological systems 150, data collection system 155 and/or provider systems 160. The trained predictive models can then process the unlabeled input data elements to predict neural responses, behavioral responses, and/or perform one or more tasks. A result for each identified neural stimuli scheme, behavioral stimuli scheme, task, test subject, etc. may include or may be based on neural response prediction, behavioral response prediction, and/or task completion from one or more predictive models of the trained predictive models deployed by the classifier subsystems 110a-n. For example, predicted neural responses can include or may be based on output generated by the fully connected layer of one or more predictive models. In some instances, such outputs may be further processed using (for example) a softmax function. Further, the outputs and/or further processed outputs may then be aggregated using an aggregation technique (e.g., random forest aggregation) to generate one or more subject or task-specific metrics. One or more results (e.g., that include plane-specific outputs and/or one or more subject-specific outputs and/or processed versions thereof) may be transmitted to and/or availed to the user device 170. In some instances, some or all of the communications between the DNN system 105, biological systems 150, data collection system 155, provider systems 160, and/or the user device 170 occurs via one or more networks 175 and/or interfaces such as a website. It will be appreciated that the DNN system 105 may gate access to results, data and/or processing resources based on an authorization analysis.

While not explicitly shown, it will be appreciated that the computing environment 100 may further include a developer device associated with a developer. Communications from a developer device may indicate what types of input image elements are to be used for each predictive model in the DNN system 105, a number of neural networks to be used, configurations of each neural network including number of hidden layers and hyperparameters, and how data requests are to be formatted and/or which training data is to be used (e.g., and how to gain access to the training data).

### Neural Predictive Model Overview

As discussed herein in detail, most neural response data such as cortex scans from in vivo experimental conditions are too noisy for regularizing task models. Accordingly, various embodiments are directed to in silico models that can take neural stimuli such as images and predict the neural response of a biological system to the neural stimuli. The use of in silico model neuron responses as a proxy for the real in vivo neurons enables isolation of the relevant features from the biological system (e.g., brain) for use to regularize the artificial intelligence system. For example, the in silico predictive model eliminates random noise and the model's shifter and modulator circuits can be configured to account for the irrelevant non-stimuli data such as eye and body movements, and thereby extract the purely visual stimuli-driven responses. Extensions of the in silico predictive model can be used to extract all kinds of other features from the brain including the structure of the noise which can also be used as an additional regularizer. Mimicking neural noise can be used to bias AI models towards more probabilistic representations of sensory information.

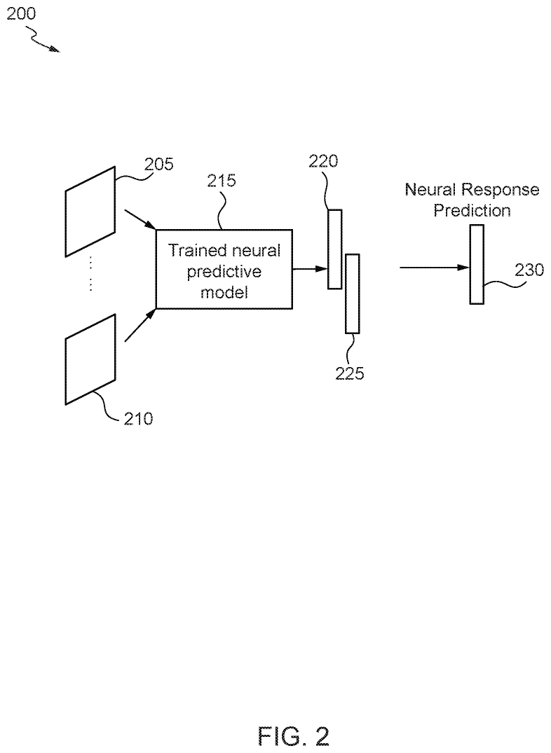

FIG. 2 illustrates an exemplary schematic diagram 200 representative of a neural predictive model architecture (e.g., a portion of the DNN system 105 described with respect to FIG. 1) for predicting a neural response (e.g., a response of a neuron or set of neurons accordance with various embodiments. In some embodiments, neural stimulus 205 (e.g., a sensory stimulus) such as images are obtained from a source (e.g., data collection system 155 and/or provider systems 160), as described with respect to FIG. 1). The neural stimulus 205 may be structured as one or more arrays or matrices of data values, e.g., pixel or voxel values. In some instances, a given pixel or voxel position may be associated with (for example) a general intensity value and/or an intensity value as it pertains to each of one or more gray levels and/or colors (e.g., RGB values). In some embodiments, supplemental data 210 such as behavioral data (e.g., pupil position, size, and movement) are obtained from a same or different source (e.g., data collection system 155 and/or provider systems 160), as described with respect to FIG. 1). The supplemental data 210 may be input into a predictive model with the neural stimulus 205 to account for non-stimuli variables.

Neural response prediction may be performed by one or more trained neural predictive models 215 (e.g., a first neural predictive model associated with classifier subsystem 110a and a second neural predictive model associated with classifier subsystem 110b as described with respect to FIG. 1). In some instances, the trained neural predictive models 215 can be one or more machine-learning models, such as a convolutional neural network (CNN), e.g. an inception neural network, a residual neural network or ResNet, a recurrent neural network, e.g., long short-term memory (LSTM) models or gated recurrent units (GRU) models or a recurrent convolutional neural network (e.g., R-CNN, fast R-CNN and faster R-CNN). The trained neural predictive models 215 can also be any other suitable ML model trained to predict neural responses from stimulus, such as a three-dimensional CNN, e.g., inception 3D neural network, a dynamic time warping technique, a hidden Markov model (HMM), etc., or combinations of one or more of such techniques—e.g., CNN-HMM or MCNN (Multi-Scale Convolutional Neural Network). In some embodiments, each of the trained neural predictive models 215 are a 3-layer CNN with skip connections.

In various embodiments, the trained neural predictive models 215 include a number of processing steps, for example, feature extraction, neural response classification, and response prediction. The pre-processed neural stimulus 205 and supplemental data 210 may be used as input into the trained neural predictive models 215. Features may be extracted from the neural stimulus 205 using a feature extractor 220 (e.g., the feature extractor 125 as described with respect to FIG. 1). The feature extractor 220 may process the neural stimulus 205 to extract relevant features (e.g., edges) detected at particular parts of the neural stimulus 205. A classifier and/or regressor 225 (e.g., the classifier and/or regressor 135 as described with respect to FIG. 1) can receive the extracted features and transform the features into a neural response 230. In one specific example, classification or regression (e.g., using the classifier and/or regressor 225) can be performed on neural stimulus 205 with consideration of supplemental data 210 to obtain an output in a desired form depending on the design of the classifier and/or regressor. In certain embodiments, the classifier and/or regressor 225 can be trained against labeled training data to predict a response 230 of a neuron or set of neurons (e.g., a population of neurons) or aggregate neural activity (e.g., EEG or BOLD fMRI responses from animals of humans). For example, the predicted response 230 of the neural predictive models 215 for a neuron α to stimulus i may be denoted as \hat{ρ}_{αi}, when the classifier and/or regressor 225 is trained to predict the raw in vivo response ρ_{αi}. The correlation between \hat{ρ}_{αi} and ρ_{αi} may be denoted as v_{α}, indicating how well neuron α is predicted by the trained neural predictive models 215. A scaled model neural response may be defined as \hat{r}_{αi}=w_{α}v_{α}\hat{ρ}_{αi} with the signal-to-noise ratio (SNR) being weight w_{α}=(signal strength σ_{α})/(noise strength η_{α}), and thus a population neural response to the stimulus i may be denoted by a vector \hat{r}ᵢ.

### Techniques for Denoising Mural Responses and Calculating a Similarity Matrix for Scaled Model Neural Responses

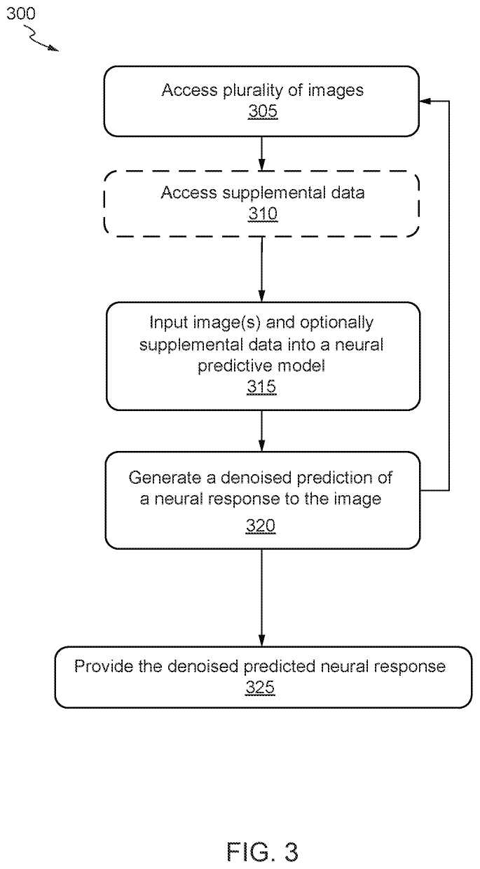

FIG. 3 illustrates a method 300 for denoising neural responses using a predictive model (e.g., predictive model 315 of the predictive model architecture described in FIG. 2). At block 305, a plurality of images are accessed for a stimulus scheme. The stimulus scheme defines a cohort of images (e.g., natural scene images) that may be used as stimulus for a biological system. Optionally at block 310, supplemental data may be accessed for the stimulus scheme. The stimulus scheme may further define the supplemental data that accounts for non-stimuli variables such as behavioral data (e.g., the pupil position and size). At block 315, the plurality of images and optionally the supplemental data are input into one or more models trained to predict a neural response. At block 320, the trained predictive models generates a prediction of a neural response to the plurality of images with optional consideration of the supplemental data. In certain embodiments, the neural response prediction is scaled and defined as \hat{r}_{αi}=w_{α}v_{α}\hat{ρ}_{αi} with the SNR being weight w_{α}=(signal strength σ_{α})/(noise strength η_{α}) to generate a denoised predicted neural response. Blocks 305-320 may be repeated to generate a plurality of denoised predicted neural responses for the image such that a denoised population neural response may be generated to the stimulus i, as denoted by a vector \hat{r}ᵢ. At block 325, the denoised predicted neural response or denoised population neural response is provided. For example, the denoised predicted neural response or denoised population neural response may be provided to a user for viewing, analysis, and/or interpretation, or may be provided to downstream processing for further analysis and/or implementation. Although, the neural stimulus is described in method 300 with respect to images it should be understood that the techniques described herein are applicable to other types of stimulus, e.g., audio or video, to stimulate other biological systems such as auditory or motor neurons.

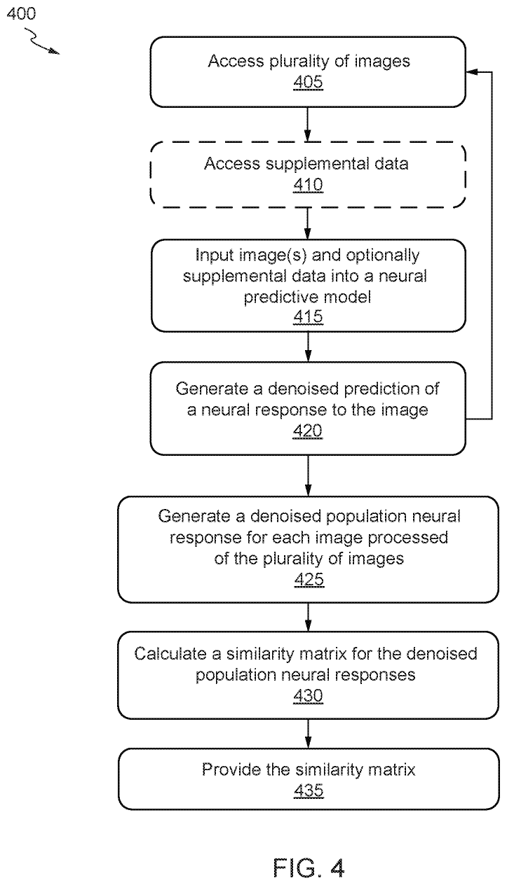

FIG. 4 illustrates a method 400 for predicting neural similarity or a similarity matrix for neural responses. A similarity metric or similarity function is a real-valued function that quantifies the similarity between two objects, for example neural responses. At block 405, a plurality of images are accessed for a stimulus scheme. The stimulus scheme defines a cohort of images (e.g., natural scene images) that may be used as stimulus for a biological system. Optionally at block 410, supplemental data may be accessed for the stimulus scheme. The stimulus scheme may further define the supplemental data that accounts for non-stimuli variables such as behavioral data (e.g., the pupil position and size). At block 415, the plurality of images and optionally the supplemental data are input into one or more models trained to predict a neural response. At block 420, the trained predictive model generates a prediction of a neural response to the plurality of images with optional consideration of the supplemental data. In certain embodiments, the neural response prediction is scaled and defined as \hat{r}_{αi}=w_{α}v_{α}\hat{ρ}_{αi} with the SNR being weight w_{α}=(signal strength σ_{α})/(noise strength η_{α}) to generate a denoised predicted neural response. Blocks 405-420 may be repeated to generate a plurality of denoised predicted neural responses for the image such that a denoised population neural response may be generated to the stimulus i, as denoted by a vector \hat{r}ᵢ. Moreover, blocks 405-420 may be repeated to generate at block 425 a plurality of denoised predicted neural responses for other images such that a denoised population neural response may be generated to the stimuli i, j, . . . , n, as denoted by individual vectors \hat{r}_{i,j . . . ,n}. At block 430, a similarity matrix for the denoised population neural responses is calculated. For example, the denoised population neural responses to the stimuli i, j, . . . n may be shifted and normalized creating centered unit vectors êᵢ=(\hat{r}ᵢ−\hat{r̅})/∥\hat{r}ᵢ−\hat{r̅}∥ where \hat{r̅}= [symbol] ᵢ[\hat{r}ᵢ], is the population response averaged over all stimuli. These unit vectors may then be used to construct a similarity matrix, according to the representation similarity metric: Sᵢⱼ^{model}=êᵢ·êⱼ for stimuli i and j. At block 435, the neural similarity or a similarity matrix is provided. For example, the neural similarity or a similarity matrix may be provided to a user for viewing, analysis, and/or interpretation, or may be provided to downstream processing for further analysis and/or implementation. Although, the neural stimulus is described in method 400 with respect to images it should be understood that the techniques described herein are applicable to other types of stimulus, e.g., audio or video, to stimulate other biological systems such as auditory or motor neurons. The pairwise representational similarity described above is just one of many possible metrics to capture the representation of information in the brain. The brain-regularization techniques described herein are applicable and cover all other kinds of neural similarity metrics (e.g., tertiary statistics and higher order statistics of the representational manifold of information (i.e. images) the brain) that can be used in the loss function during training on the AI task.

### Behavioral Predictive Model Overview

Various embodiments are directed to in silica models that can take behavioral stimuli such as triggers or task requests and predict the behavioral response of a biological system to the behavioral stimuli. For example, taking an email or other electronic request for information and responding to that request for information in a similar manner as performed by the biological system including intelligence, mannerisms, efficiency, language, etc. used in building a response to the request for information. The use of in silica model for behavioral responses as a proxy for the real in viva behavior of a subject enables the generation of an artificial intelligence system that can attune behavior for personalization of a generated response. For example, the in silica predictive model is not just extracting features from the neural activity but is extracting features from the behavioral response of the biological system as a whole including neural responses in order to predict behavior of the biological system, which can then be implemented in an artificial intelligence system to perform a task in a similar manner in which the biological system would perform the task (essentially an AI clone of the biological system for performing a given task). Extensions of the in silica predictive model can be used to extract all kinds of other features from the biological system including voice features and motor function features which can be used for a number of use cases including use of the model for deploying an AI avatar of the biological system for performing tasks, identify the best way for a biological system to learn a new task (e.g., learn a new language), perform in silica experiments of the predictive model of the behavior of the biological system to better understand how the biological system may respond to a given stimulus or task request.

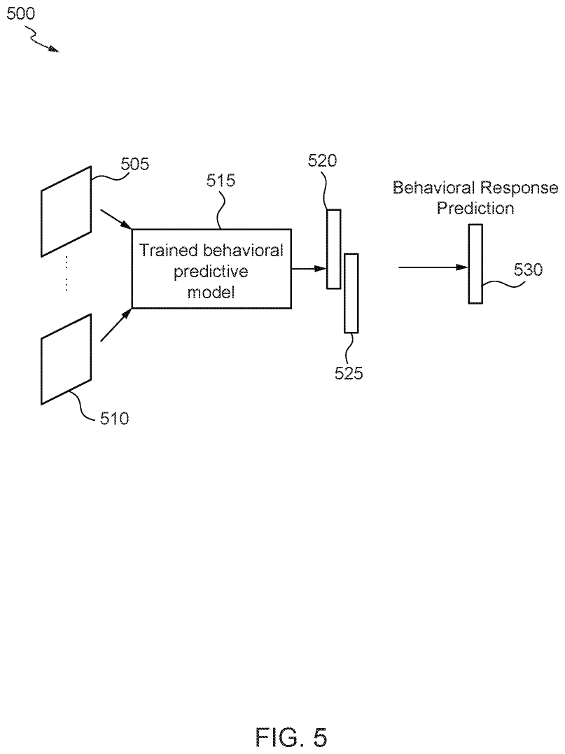

FIG. 5 illustrates an exemplary schematic diagram 500 representative of a behavioral predictive model architecture (e.g., a portion of the DNN system 105 described with respect to FIG. 1) for predicting a behavioral response (e.g., a set of behavioral responses specific to a given biological system) in accordance with various embodiments. In some embodiments, behavior stimulus 505 (e.g., a task request) such as a question for information are obtained from a source (e.g., data collection system 155 and/or provider systems 160), as described with respect to FIG. 1). The behavior stimulus 505 may be structured as one or more arrays or matrices of data values, e.g., natural language text, values, and/or pixel or voxel values. In some instances, a given natural language text, values, and/or pixel or voxel values may be associated with (for example) a general characteristic value and/or a characteristic value as it pertains to each of one or more levels and/or features within the natural language text, values, and/or pixel or voxel. In some embodiments, supplemental data 510 such as contextual data (e.g., environment in which the task is to be performed) are obtained from a same or different source (e.g., data collection system 155 and/or provider systems 160), as described with respect to FIG. 1). The supplemental data 510 may be input into a predictive model with the behavioral stimulus 505 to account for non-stimuli variables.

Behavioral response prediction may be performed by one or more trained behavioral predictive models 515 (e.g., a first behavioral predictive model associated with classifier subsystem 110a and a second behavioral predictive model associated with classifier subsystem 11011 as described with respect to FIG. 1). In some instances, the trained behavioral predictive models 515 can be one or more machine-learning models, such as a convolutional neural network (CNN), e.g. an inception neural network, a residual neural network or ResNet, a recurrent neural network, e.g., long short-term memory (LSTM) models or gated recurrent units (GRU) models or a recurrent convolutional neural network (e.g., R-CNN, fast R-CNN and faster R-CNN). The trained behavioral predictive models 515 can also be any other suitable ML model trained to predict neural responses from stimulus, such as a three-dimensional CNN, e.g., inception 3D neural network, a dynamic time warping technique, a hidden Markov model (HMM), etc., or combinations of one or more of such techniques—e.g., CNN-HMM or MCNN (Multi-Scale Convolutional Neural Network). In some embodiments, each of the trained behavioral predictive models 515 are a 3-layer CNN with skip connections.

In various embodiments, the trained behavioral predictive models 515 include a number of processing steps, for example, feature extraction, behavior response classification, and response prediction. The pre-processed behavioral stimulus 505 and supplemental data 510 may be used as input into the trained behavioral predictive models 215. Features may be extracted from the behavioral stimulus 505 using a feature extractor 520 (e.g., the feature extractor 125 as described with respect to FIG. 1). The feature extractor 520 may process the behavioral stimulus 505 to extract relevant features (e.g., edges) detected at particular parts of the behavioral stimulus 505. A classifier and/or regressor 525 (e.g., the classifier and/or regressor 135 as described with respect to FIG. 1) can receive the extracted features and transform the features into a behavioral response 530. In one specific example, classification or regression (e.g., using the classifier and/or regressor 525) can be performed on behavioral stimulus 505 with consideration of supplemental data 510 to obtain an output in a desired form depending on the design of the classifier and/or regressor. In certain embodiments, the classifier and/or regressor 525 can be trained against labeled training data to predict a behavioral response 530 of a given biological system. For example, the predicted behavioral response 530 of the behavioral predictive models 515 for a behavioral component such as a neuron, a muscle, an audible noise (e.g., spoken word), or the like a to behavioral stimulus i may be denoted as \hat{ρ}_{αi}, when the classifier and/or regressor 525 is trained to predict the raw in vivo behavioral response ρ_{αi}. The correlation between \hat{ρ}_{α1} and ρ_{αi} may be denoted as v_{α}, indicating how well neuron, a muscle, an audible noise (e.g., spoken word), or the like α is predicted by the trained behavioral predictive models 515. A scaled model behavioral response may be defined as \hat{r}_{αi}=w_{α}v_{α}\hat{ρ}_{αi} with the signal-to-noise ratio (SNR) being weight w_{α}=(signal strength σ_{α})/(noise strength η_{α}), and thus a population or multi-system behavioral response to the stimulus i may be denoted by a vector \hat{r}ᵢ.

### Techniques for Predicting Behavioral Responses

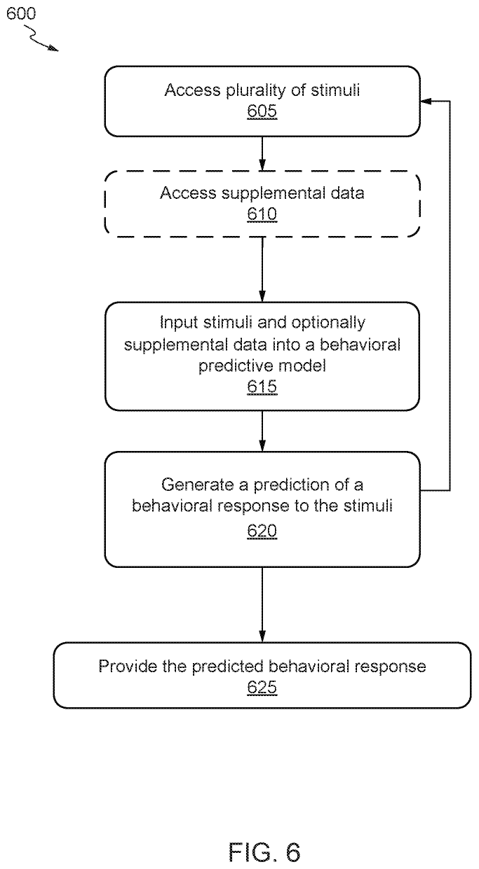

FIG. 6 illustrates a method 600 for predicting behavioral responses using a predictive model (e.g., predictive model 515 of the predictive model architecture described in FIG. 5). At block 605, one or more of stimuli, triggers, and/or behavioral requests are accessed for a stimulus scheme. The stimulus scheme defines a cohort of stimuli, triggers, and/or behavioral requests (e.g. audio or video, to stimulate biological systems such as auditory or motor systems, verbal/written requests to perform a task, stimuli provoking a behavioral response, or the like) that may be used as behavioral stimulus for a biological system. Optionally at block 610, supplemental data may be accessed for the stimulus scheme. The stimulus scheme may further define the supplemental data that accounts for non-stimuli variables such as contextual data (e.g., the environment in which the task is to be performed). At block 615, the one or more of stimuli, triggers, and/or behavioral requests and optionally the supplemental data are input into one or more models trained to predict a behavioral response. At block 620, the trained predictive models generates a prediction of a behavioral response to the one or more of stimuli, triggers, and/or behavioral requests with optional consideration of the supplemental data. In certain embodiments, the behavioral response prediction is scaled and defined as \hat{r}_{αi}=w_{α}v_{α}\hat{ρ}_{αi} with the SNR being weight w_{α}=(signal strength σ_{α})/(noise strength η_{α}) to generate a predicted behavioral response. Blocks 505-520 may be repeated to generate a plurality of predicted behavioral responses for the one or more of stimuli, triggers, and/or behavioral requests with optional consideration of the supplemental data such that a multi-system behavioral response may be generated to the behavioral stimulus i, as denoted by a vector \hat{r}ᵢ. At block 625, the predicted behavioral response or multi-system behavioral response is provided. For example, the predicted behavioral response or multi-system behavioral response may be provided to a user for viewing, analysis, and/or interpretation, or may be provided to downstream processing for further analysis and/or implementation. More specifically, the predicted behavioral response or multi-system behavioral response can be used for a number of use cases including use of an AI avatar of the biological system for performing tasks, identify the best way for a biological system to learn a new task (e.g., learn a new language), perform in silico experiments of the behavior of the biological system to better understand how the biological system may respond to a given stimulus or task request

### Task Predictive Model Overview

As discussed herein in detail, regularization and implicit inductive biases in deep networks such as task predictive models can positively affect robustness and generalization by constraining the parameter space and biasing the trained task predictive models to use better features. However, these biases are often rather nonspecific and task predictive models often latch onto patterns that do not generalize well outside the distribution of training data. Accordingly, various embodiments are directed to biasing task predictive models towards a biological feature space, which can better cope with varied conditions and generalization. For example, a modified loss function can be defined with (i) conventional loss used to define performance of the task (e.g., classification or 1-shot learning), and (ii) a similarity loss function that defines biological system representation with a similarity matrix. The similarity loss plays the role of a regularizer, and biases the task predictive model towards the biological system representation. The use of the modified loss function to regularize task predictive models has the major advantage of creating an inductive bias towards more robust inference (robustness to noise and adversarial attacks).

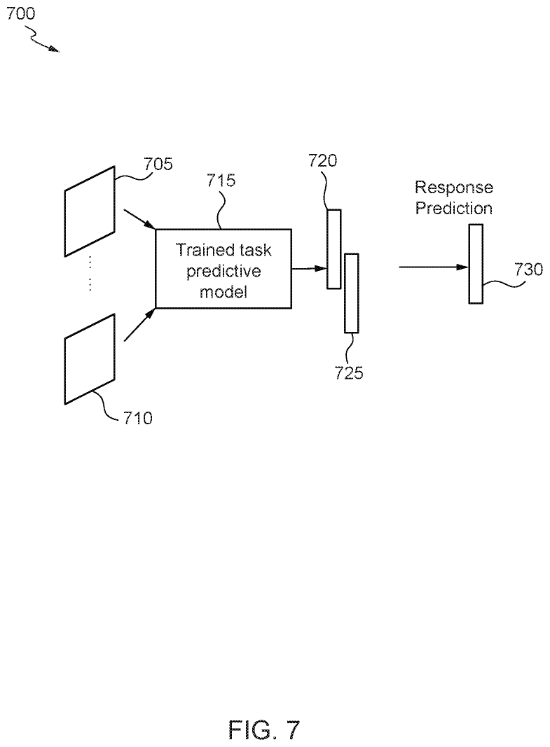

FIG. 7 illustrates an exemplary schematic diagram 700 representative of a task predictive model architecture (e.g., a portion of the DNN system 105 described with respect to FIG. 1) for performing a task (e.g., classification, nearest neighbor, one-shot learning, regression analysis, clustering, anomaly detection, and the like) in accordance with various embodiments. In some embodiments, input data 705 such as images are obtained from a source (e.g., data collection system 155 and/or provider systems 160), as described with respect to FIG. 1). The input data 705 may be structured as one or more arrays or matrices of data values, e.g., pixel or voxel values including temporal series. In some instances, a given pixel or voxel position may be associated with (for example) a general intensity value and/or an intensity value as it pertains to each of one or more gray levels and/or colors (e.g., RGB values). In some embodiments, supplemental data 710 such as contextual or mechanistic data are obtained from a same or different source (e.g., data collection system 155 and/or provider systems 160), as described with respect to FIG. 1). The supplemental data 710 may be input into a predictive model with the input data 705 to account for non-input data variables such as weather conditions or time of day.

Task prediction may be performed by one or more trained task predictive models 715 (e.g., a first task predictive model associated with classifier subsystem 110c and a second task predictive model associated with classifier subsystem 110d as described with respect to FIG. 1). In some instances, the trained task predictive models 715 can be one or more machine-learning models, such as a convolutional neural network (CNN), e.g. an inception neural network, a residual neural network or ResNet, a recurrent neural network, e.g., long short-term memory (LSTM) models or gated recurrent units (GRU) models or a recurrent convolutional neural network (e.g., R-CNN, fast R-CNN and faster R-CNN). The trained neural predictive models 215 can also be any other suitable ML model trained to predict neural responses from stimulus, such as a three-dimensional CNN, e.g., inception 3D neural network, a dynamic time warping technique, a hidden Markov model (HMM), etc., or combinations of one or more of such techniques—e.g., CNN-HMM or MCNN (Multi-Scale Convolutional Neural Network). In some embodiments, each of the trained task predictive models 715 are an 18-layer ResNet with skip connections.

In various embodiments, the trained task predictive models 715 include a number of processing steps, for example, feature extraction, input data classification, and prediction. The pre-processed input data 705 and supplemental data 710 may be used as input into the trained task predictive models 715. Features may be extracted from the input data 705 using a feature extractor 720 (e.g., the feature extractor 125 as described with respect to FIG. 1). The feature extractor 720 may process the input data 705 to extract relevant features (e.g., edges) detected at particular parts of the input data 705. A classifier and/or regressor 725 (e.g., the classifier and/or regressor 135 as described with respect to FIG. 1) can receive the extracted features and transform the features into a predicted response 730 (e.g., predicted identification of a human in an image). In one specific example, classification or regression (e.g., using the classifier and/or regressor 725) can be performed on the input data 705 with consideration of supplemental data 710 to obtain an output in a desired form depending on the design of the classifier and/or regressor.

In certain embodiments, the classifier and/or regressor 725 can be jointly trained to both classify the input data 705 and predict neural similarity, as described with respect to FIG. 4. For example, the trained task predictive models 715 may take either one image or a pair of images or sets of images as inputs, with a same convolutional core. If the input is one image with the right size, the feature extractor 720 and classifier and/or regressor 725 work together to output a class prediction with an additional fully connected layer. If the input is a pair of images, the feature extractor 720 and classifier and/or regressor 725 first calculate the convolutional features for both images, and calculate the similarity for one or more of the hidden layers (e.g., a random selection of hidden layer or all of the hidden layers). Similarity predictions from different layers are summed up by a trainable normalized weight to produce a final prediction, which is trained to match neural similarity. Two losses are then summed with a coefficient α as the regularization strength and implemented within the same convolutional core in order to regularize the trained task predictive models 715 for future predictions. The pairwise similarity measure may be applied to other forms of representational similarity.

### Techniques for Neural Regularization of Task Predictive Models

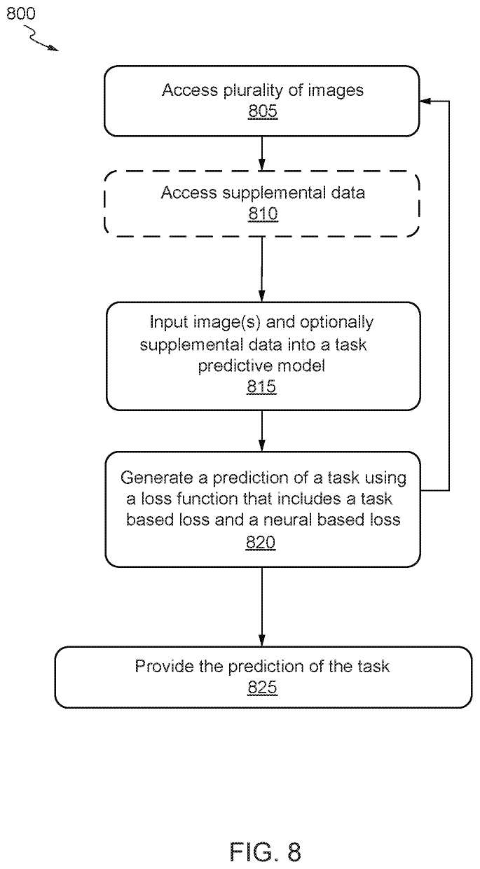

FIG. 8 illustrates a method 800 for neural regularization of a predictive model (e.g., predictive model 515 of the predictive model architecture described in FIG. 5), At block 805, a plurality of images are accessed for a task scheme. The task scheme defines a cohort of images (e.g., natural scene images) that are to be processed using one or more tasks (e.g., processed to classify an object within an image). Optionally at block 810, supplemental data may be accessed for the task scheme. The task scheme may further define the supplemental data that accounts for non-image variables such as contextual or mechanistic data (e.g., the weather or shutter speed). At block 815, the plurality of images and optionally the supplemental data are input into one or more models jointly trained to output a task prediction (e.g., a class prediction). At block 820, the trained predictive models generate a prediction of a task with optional consideration of the supplemental data. The generation includes application of a loss function within the classifier and/or regressor. The loss function includes task based loss and neural based loss. The neural based loss favors biological system representations using the predicted neural similarity as described with respect to FIG. 4 and a coefficient α to determine regularization strength. At block 825, the prediction of the task is provided. For example, the prediction of the task may be provided to a user for viewing, analysis, and/or interpretation, or may be provided to downstream processing for further analysis and/or implementation. Although, the neural stimulus is described in method 800 with respect to images it should be understood that the techniques described herein are applicable to other types of stimulus, e.g., audio or video, to stimulate other biological systems such as auditory or motor neurons.

### III. EXAMPLES

The systems and methods implemented in various embodiments may be better understood by referring to the following examples.

### Neural Representation Similarity

During in vivo experiments, head-fixed mice were able to run on a treadmill while passively viewing natural images (neural stimulus) that were each presented for 500 ms. each experiment, neural responses were measured for 5100 different grayscale images sampled from the ImageNet dataset, 100 of which were repeated 10 times to obtain 6000 trials in total. Each image was downsampled by a factor of four to 64×36 pixels. The 100 repeated images were labeled as ‘oracle images’, because the mean neural responses over these repeated trials were used as a high quality predictor (oracle) for validation trials. The neural responses of the mice were measured by performing several 2-photon scans on the primary visual cortex of the mice, with repeated scans per mouse across different days.

A similarity metric was defined for the neural responses, which was then used to regularize a CNN (a task predictive model) for image classification. In a first step, the raw response ρ_{αi} for each neuron α to stimulus i is scaled by its signal-to-noise ratio (SNR):

$${w}_{a} = \frac{{σ}_{a}}{{η}_{a}} \qquad Equation ( 1 )$$

where the SNR is weight w_{α} (signal strength σ_{α})/(noise strength η_{α}), which was estimated from responses to repeated stimuli, namely the oracle images. For a neuron α, the signal strength σ_{α}²=Varᵢ( [symbol] ₜ[r_{αit}]) is the variance over stimuli i of the mean response over repeated trials t. The noise strength is the mean over stimuli of the variance over trials η_{α}²= [symbol] ᵢ[Varₜ(r_{αit})]. The scaled response may be denoted by r_{αi}=w_{α}v_{α}ρ_{αi}. The scaled population response to stimulus i is the vector rᵢ. The scaling responses based on signal-to-noise ratio accounts for the reliability of each neuron by reducing the influence of noisy neurons. For example, if the responses of a neuron to the same images are highly variable, the image's contribution to the similarity metric may be ignored by assigning a small weight to it, no matter how differently it responds to different images or how high its responses are in general.

The population responses represented by vector rᵢ. may then be shifted and normalized creating centered unit vectors eᵢ=(rᵢ−r̅)/∥rᵢ−r̅∥ where r̅∥ where r̅= [symbol] ᵢ[rᵢ], is the population response averaged over all stimuli. These unit vectors may then be used to construct a similarity matrix, according to the representation similarity metric:

Sᵢⱼ^{data}=eᵢ·eⱼ Equation (2)

for stimuli i and j.

### Stability Across Test Subjects and Days

Averaging the responses to the repeated presentations of the oracle images allowed for reduction of the influence of neural noise in the representation similarity metric defined in Equation (2) and examine stability of the representation similarity metric across scans different selections of neurons). When calculating similarity between oracle images, it is possible to average the results of different trials to reduce noise. For given image i with T repeats, first those trials may be treated as if they are different images iₗ . . . i_{T}, and calculate similarity against repeated trials of another oracle image j, (jₗ . . . j_{T}) in every combination. An oracle representation similarity metric may be defined as the mean value of all trial similarity values:

$$\begin{matrix}{S}_{ij}^{oracle} = {𝔼}_{{t}_{i} , {t}_{j}} [ {S}_{{i}_{{t}_{i}} {j}_{{t}_{j}}}^{data} ] & Equation ( 3 ) \\ with [ {S}_{{i}_{{t}_{i}} {j}_{{t}_{j}}}^{data} ] = 1 excluded when i = j . & \end{matrix}$$

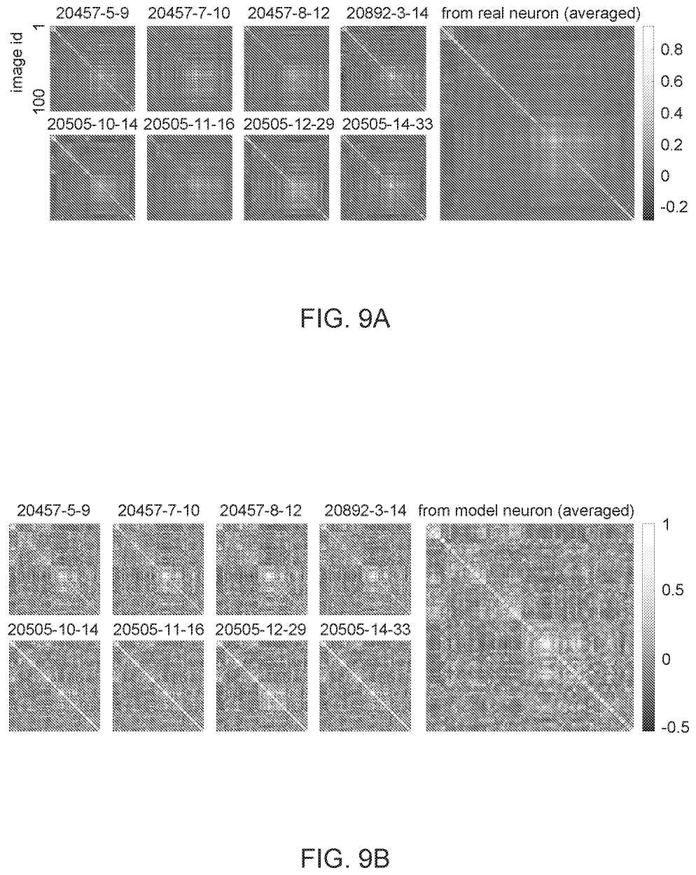

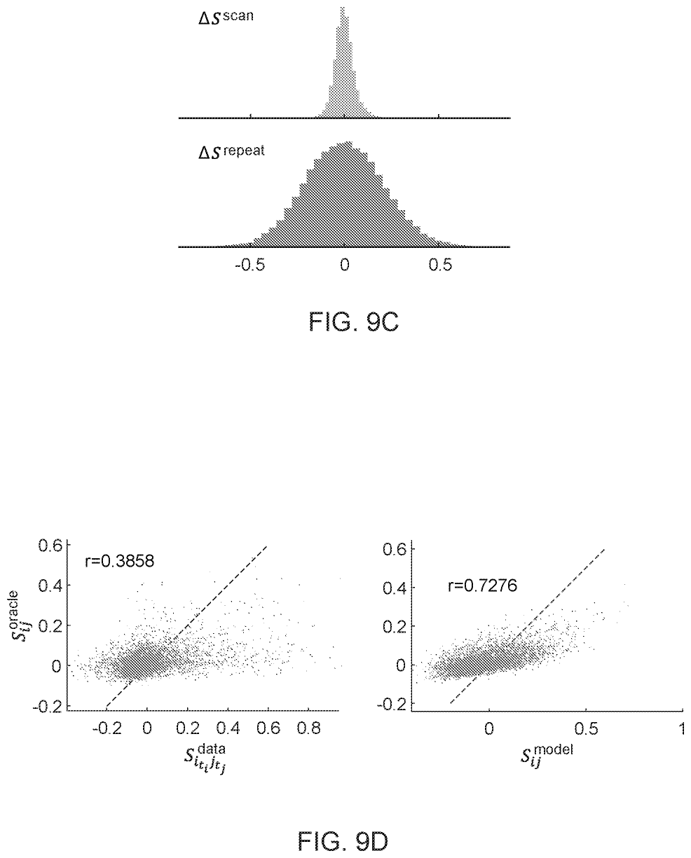

The neural representation similarity metric between images was found to be stable across scans and across mice in the primary visual cortex (FIG. 9A). Specifically, FIG. 9A shows the oracle representation similarity metric defined in Equation (3) from real neural responses to the 100 oracle images. The structure of the oracle representation similarity metric is shown stable across scans on different mice and days. When images (columns and rows) are ordered for better visualization, there is a visible structure consistent across scans, revealing the clustering organization of these images. The similarity matrix developed with the oracle representation similarity metric can be indexed for a particular scan h as Sᵢⱼ^{oracle-h}, and the fluctuation across scans can be compared:

ΔS_{h,i,j}^{scan}=Sᵢⱼ^{oracle-h}− [symbol] ₕ[Sᵢⱼ^{oracle-h}] Equation (4)

and the fluctuation across repeats:

ΔS^{repeat}_{h,i,t}_{₁}_{,t}_{₂}=S^{data-h}ᵢ_{ₜ}_{₁}ᵢ_{ₜ}_{₂}−Sᵢᵢ^{oracle-h} Equation (5)

A much narrower distribution may be observed for ΔS^{scan} than ΔS^{repeat}, which is shown in FIG. 9C (variability over scans is smaller than that over repeats), suggesting that the variability due to the selection of neurons (scans) is much lower that the single trial variability to the same image.

### Denoising Neural Responses with a Predictive Model

Most images in the in vivo experiments were only presented once to maximize the diversity of stimuli, so S^{oracle} is not available for them while S^{data} was too noisy for purposes of determining similarity across images. To exploit the neural responses for non-oracle images (images presented once), a predictive model (a neural predictive model) was trained to denoise data. The predictive model was comprised of a 3-layer CNN with skip connections. The predictive model takes images during in silico experiments as inputs and predicts neural responses by a linear readout at the last layer, in addition, behavioral data. such as the pupil position and size, as well as the running speed on the treadmill were also fed to the predictive model to account for the effect of non-visual variables.

The predicted response for a neuron a to stimulus i may be denoted as \hat{ρ}_{αi}, when the classifier or regressor is trained to predict the raw in vivo response ρ_{αi}. The correlation between \hat{ρ}_{αi} and ρ_{αi} may be denoted as v_{α}, indicating how well neuron α is predicted by the predictive model. A scaled model neural response may be defined as \hat{r}_{αi}=w_{α}v_{α}\hat{ρ}_{αi} with the SNR being weight w_{α} =(signal strength σ_{α})/(noise strength η_{α}) as defined by Equation (1), and thus a population neural response to the stimulus i may be denoted by a vector \hat{r}ᵢ. The similarity matrix for scaled model responses, according to the representation similarity metric, may be calculated in a similar manner to Equation (2):

Sᵢⱼ^{model}=êᵢ·êⱼ Equation (6)

Similarity matrices for the same set of oracle images are shown in FIG. 9B according to Equation (6), each from a predictive model trained for the corresponding scan. The similarity for measured neural responses. S^{oracle}, are also present in the predictive model response similarities, but the structure is more prominent for the predictive model responses. A scatter plot of data and model similarities, Sᵢⱼ^{oracle}, versus Sᵢⱼ^{model}, (shown in FIG. 9D), shows a high correlation r=0.73, but the model similarities have a wider range. In the same plot it is also shown that the correlation between S^{oracle} and the corresponding trial similarity values S^{data} from which they are estimated, and found, S^{model} to be much less noisy than, S^{data}.

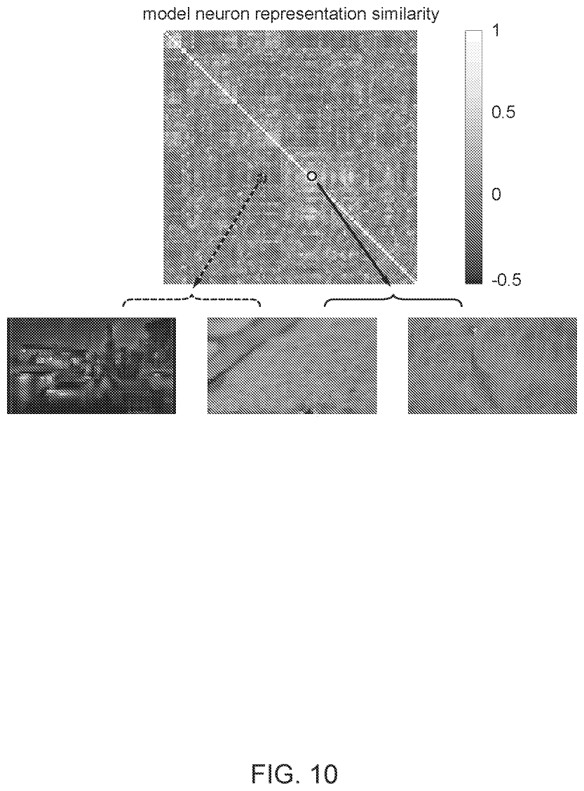

The use of the predictive model neuron responses as a proxy for the real neurons has three major benefits. First, the outputs are deterministic, eliminating the random noise component. Second, the predictive model was heavily regularized during training, so these deterministic responses are more likely to reflect reliable visual features. Third, the model's shifter and modulator circuit accounted for the irrelevant nonvisual eye and body movements, and could thereby extract more of the purely visual-driven responses. With the help of the predictive model, it was possible to obtain cleaner responses for the 5000 non-oracle images even though they are only measured once. The similarity matrices averaged over 8 scans were able to be used as a regularization target. Two examples of the model neural similarity for the 100 oracle images are shown in FIG. 10.

### Neural Regularization by Joint Training

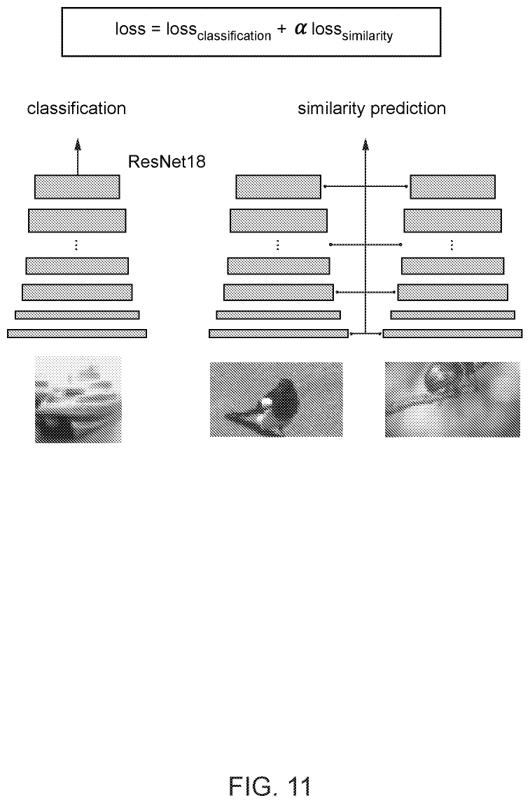

To regularize a standard machine learning model (task predictive model) with the representation similarity matrix obtained from the neural data, the task predictive model was jointly trained with a similarity loss in addition to the model's original task-defined loss. FIG. 11 shows a joint training schematic comprising training of a ResNet18 model to both classify CIFAR10 images and predict neural similarity of ImageNet images used in scans of the aforementioned experiments. The network takes either one image or a pair of images as inputs, with a same convolutional core. If the input is one image with the right size, the model outputs class prediction with an additional fully connected layer. If the input is a pair of images, the model first calculates the convolutional features for both, and calculates the similarity for a few selected layers (see, e.g., Equation (10)). Similarity predictions from different layers are summed up by a trainable normalized weight to produce a final prediction, which is trained to match neural similarity (see, e.g., Equation (6)).

The two losses are summed with a coefficient as the regularization strength. The full loss function contains two terms, defined as:

L=Lₜₐₛₖ+αL_{similarity} Equation (7)

where the first term is a conventional loss used to define the performance on the task, such as classification or 1-shot learning. In this section, a grayscale CIFAR10 classification task was implemented, hence a cross-entropy loss was used as the conventional loss term. The second term is the penalty that favors brain-like representations, with a coefficient α determining regularization strength. For any pair of images that were shown to the mice, there was a representational similarity already provided from models predicting neural data (Equation (6)). Since the similarity is now being compared for two models, a neural predictive model and a task predictive model based on a convolutional neural network, the former similarity may be denoted as Sᵢⱼ^{neural} and the latter may be denoted as Sᵢⱼ^{task}. We want as S^{task} approximate S^{neural} well. The similarity loss for image i and image j may be defined as:

L_{similarity}=[arctanh(Sᵢⱼ^{task})−arctanh(Sᵢⱼ^{neural})]² Equation (8)

The arctanh may be used to remap the similarities from the [−1, 1] to (−∞, ∞). When similarity values are not too close to −1 or 1, the loss is close to the sample based centered kernel alignment (CKA) index.

Intuitively, S^{task} is the cosine similarity of convolutional features that image i and j activate. However, not all convolutional layers of the task predictive model may be used, nor is any one layer selected to predict the representational similarity. Instead, a number of layers may be selected from the task predictive model (e.g., layers n selected from bottom to top or top to bottom of the task predictive model), a similarity prediction may be calculated for each selected layer, the similarity prediction results for all selected layers may be averaged through one or more trainable weights. The weights may be the output of a softmax function, therefore guaranteed to be positive and sum to one. For each of the selected layers (K) a cosine similarity value may be calculated as follows:

$${S}_{ij}^{task - k} = \frac{( {f}_{i}^{( k )} - {\overline{f}}^{( k )} ) \cdot ( {f}_{j}^{( k )} - {\overline{f}}^{( k )} )}{‖ {f}_{i}^{( k )} - {\overline{f}}^{( k )} ‖ ‖ {f}_{j}^{( k )} - {\overline{f}}^{( k )} ‖} \qquad Equation ( 9 )$$

where ƒᵢ^{(k)} is the concatenated convolutional feature vector for image i at layer k, and ƒ̅^{(k)}= [symbol] ᵢ[ƒᵢ^{(k)}] is its mean over images. The final model similarity is a combination from all selected layers defined as:

$${S}_{ij}^{task} = {\sum }_{k} {γ}_{k} {S}_{ij}^{task - k} \qquad Equation ( 10 )$$

where γₖ is a trainable probability with Σₖγₖ=1, γₖ>=0. This means that the objective function can choose which layer to match similarity, but it needs to match at least one in total as enforced by the softmax that determines γₖ. In the experimental simulations, layers 1, 5, 9, 13, and 17 of a ResNet18 were selected, and the preliminary analysis shows the greatest contribution comes from layer 5 (the last layer of the first ResBlock).

In each step of training the task predictive model, first a hatch of CIFAR images were processed to calculate classification loss L_{classification}, and subsequently process a hatch of image pairs sampled from the stimuli used in the aforementioned experiments, calculating the similarity loss L_{similarity} with respect to the pre-computed S^{neural} matrix. The gradient of the full loss may affect the CNN kernel weights through both loss terms.

### Results

### Robustness Against Random Noise

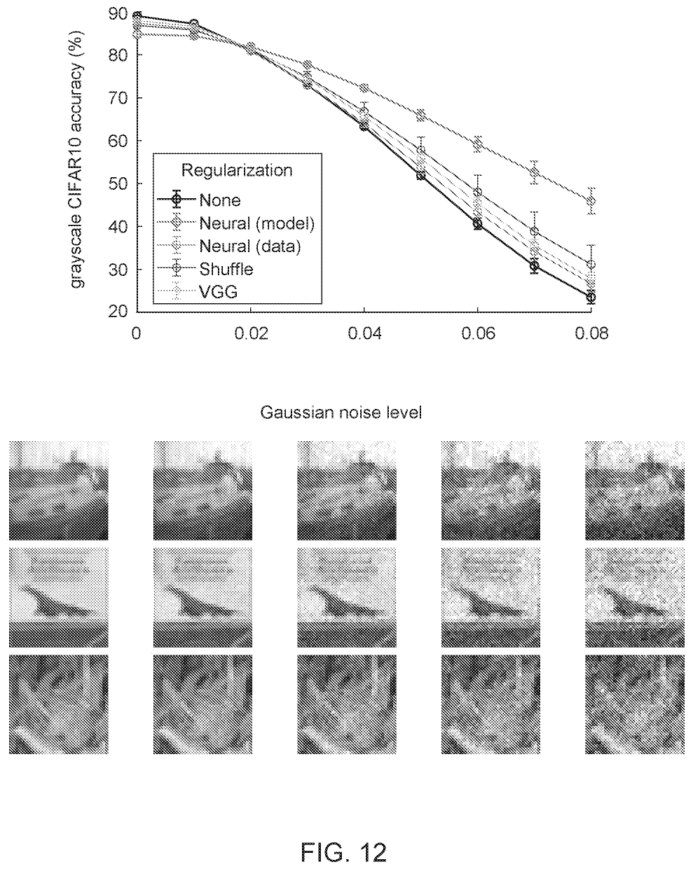

The similarity loss plays the role of a regularizer, and it biases the task predictive model towards a more brain-like representation. It was observed that the task predictive model becomes more robust to random noise when neural regularization is used. FIG. 12 shows performance robustness of task predictive models to Gaussian noise. All models were trained by stochastic gradient descent for 40 epochs with batch size 64. Learning rate starts at 0.1 and decays by 0.3 every 4 epochs, but resets to 0.1 after the 20th epoch. Mean classification accuracy for CIFAR10 test set over 5 random seeds is reported in FIG. 12. PyTorch was used for model training. The CIFAR10 classification performance was tested under different levels of Gaussian noises on input images for the jointly trained ResNet model, and compared with models with no regularization and some other regularization. Compared to a network with no regularization (‘None’), all regularized models have higher classification accuracy when discernible noise is added. In particular, a model regularized with model neural similarity outperforms others on noisy images, only with a small sacrifice on clean image performance. The error bars here are standard error of mean (SEM), with 5 random seeds used for each regularizer. The reduced improvement from ‘Neural (data)’ emphasizes the need for a good neural predictive model for denoising, so that the actual neural representation structure can be exploited.

Compared to a ResNet18 trained without any regularization (‘None’ in FIG. 12), the same architecture equipped with the neural regularizer (‘Neural (model)’ in FIG. 12) had substantially better performance on noisy input images (50% v.s. 20% at the highest noise level). In other words, task predictive models whose features are more neural are less vulnerable to random noise in inputs. To strengthen this conclusion, the task predictive model was also regularized with a shuffled S^{neural} matrix (‘Shuffle’ in FIG. 10) or the feature similarity matrix of the conv3-1 layer in a VGG19 model pretrained on ImageNet (‘VGG’ in FIG. 12). This VGG layer has been reported to be most similar to animal V1. Both regularizers improve the task predictive model robustness to some degree but neither as much as using the neural regularizer. Finally, the task predictive model was also regularized with a similarity matrix from the actual data directly (‘Neural (data)’ in FIG. 12), using S^{data} (Equation (2)) instead of S^{model} (Equation (6)). However, the same boost in robustness was not observed. This is most likely caused by the high variability of the neural responses, highlighting the need for a well-trained neural predictive model to demise the neural responses. Only with a strong predictive system identification model as a denoiser were the task predictive model able to reveal the underlying representational structure hidden in the noisy neural data.

### Robustness Against Adversarial Attack

As discussed herein, the similarity loss plays the role of a regularizer, however there was also interested in whether neural regularization provides robustness to adversarial attacks. Since adversarial examples and their innocent counterparts elicit the same percept by definition, it is highly possible that their measured neural representations are also close to each other. Thus, a model with neural representation will be more invariant to adversarial noise. The task predictive model robustness was evaluated using the well-tested attack implementations provided by Foolbox. The evaluation metric comprised striving to find adversarial perturbations (i.e., perturbations that flip a label to any but the ground-truth class) with the minimum norm (either L₂ or L_{∞}) for each of 1000 test samples. The median perturbation distance was then calculated across all samples as a final robustness score (higher is better). Besides the current state-of-the-art attacks on L₂ and L_{∞}, a recently developed gradient-based version of the decision-based boundary attack was deployed, which surpasses in terms of query efficiency and the size of the minimal adversarial perturbations. In short, the gradient-based version of the decision-based boundary attack starts from a natural input sample that is classified as different from the original image (for which we aim to generate an adversarial example). The algorithm then performs a line search between the two images to find the decision boundary of the model. The gradients with respect to the difference between the two top-most logits allow the local geometry of the decision boundary to be estimated. Using this geometry it is possible to compute the optimal adversarial perturbation that (a) takes us exactly to the boundary (in case we are slightly shifted away from it), (b) stays within the valid pixel bounds, (c) minimizes the distances to the original image, and (d) is not too far from the current perturbation (to make sure we stay within the region for which the linear approximation of the boundary is valid). Therefore, the gradient-based version of the decision boundary attack provides a most stringent test for adversarial robustness of the task predictive models regularized with neural data.

To ensure that all models are evaluated and compared fairly, an extensive hyperparameter search was performed and the optimal combination was selected. Since the gradient-based boundary attack proved more effective on all task predictive models tested herein, the gradient-based boundary attack was only deployed for L₂, and projected gradient descent (PGD) was used for L_{∞} in the final evaluation. For the gradient-based boundary attack, step sizes of {0.0003, 0.001, 0.003, 0.01, 0,03, 0.1, 0.03} were tested, and for PGD step sizes of {10⁻⁶, 10⁻⁵, 10⁻⁴, 10⁻³, 10⁻², 10⁻¹, 1} were tested with iterations of {10, 30, 50, 100, 200}.

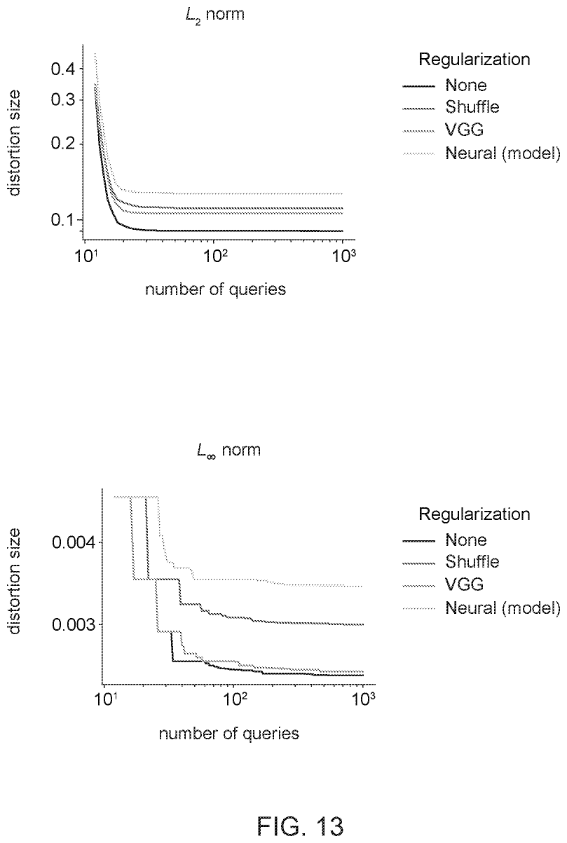

FIG. 13 shows that regularizing models with neural representational similarity improves model robustness against adversarial attacks. The model with the smallest adversarial perturbations (most fragility) is the task predictive model trained, without any regularization (median perturbation of 0.0025 (L_{∞}) and 0.09 (L₂)). Regularizing with random similarity matrix (median perturbation of 0.003 (L_{∞}) and 0.11 (L₂)) or similarity of VGG features (median perturbation of 0.0028 (L_{∞}) and 0.11 (L₂)) increases robustness. The strongest increase in robustness, in both metrics, is provided by the regularization with the brain's representations learned from neural data (median perturbation of 0.0034 (L_{∞}) and 0.13 (L₂)).

### IV. Additional Considerations

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

1. A method comprising:
accessing, by a computing system, a plurality of stimuli for a stimulus scheme;
inputting, by the computing system, a first stimulus of the plurality of stimuli into a neural predictive model;
generating, by the neural predictive model, a prediction of a first neural response of a biological system to the first stimulus;
scaling, by the neural predictive model, the predicted first neural response with a signal-to-noise weight to generate a denoised predicted first neural response; and
providing, by the computing system, the denoised predicted first neural response.

2. The method of claim 1, wherein the signal-to-noise weight (w_{α})=(signal strength σ²_{α})/(noise strength η²_{α}), where α is a given neuron of the biological system.

3. The method of claim 1, wherein the scaled predicted first neural response is defined as \hat{r}_{α1}=w_{α}v_{α}\hat{p}_{αi}, where (w_{α})=(signal strength σ²_{α})/(noise strength η²_{α}), α is a given neuron of the biological system and i is the first stimulus, and v_{α} is a correlation between an actual neural response of the biological system to the first stimulus and the predicted first neural response of the biological system.

4. The method of claim 1, wherein the neural predictive model is a convolutional neural network, the plurality of stimuli are a plurality of images, and the first stimulus is a first image.

5. The method of claim 1, further comprising:
repeating the inputting of the first stimulus to generate, by the neural predictive model, a plurality of denoised predicted first neural responses for the first stimulus; and
generating, by the neural predictive model, a denoised population first neural response based on the plurality of denoised predicted first neural responses, wherein the denoised population first neural response is a vector of the plurality of denoised predicted first neural responses for the first stimulus.

6. The method of claim 5, further comprising:
inputting, by the computing system, a second stimulus of the plurality of stimuli into the neural predictive model;
generating, by the neural predictive model, a prediction of a second neural response of the biological system to the second stimulus;
scaling, by the neural predictive model, the predicted second neural response with the signal-to-noise weight to generate a denoised predicted second neural response;
repeating the inputting of the second stimulus to generate, by the neural predictive model, a plurality of denoised predicted second neural responses for the second stimulus; and
generating, by the neural predictive model, a denoised population second neural response based on the plurality of denoised predicted second neural responses, wherein the denoised population second neural response is a vector of plurality of denoised predicted second neural responses for the second stimulus.

7. The method of claim 6, further comprising:
shifting and normalizing, by the neural predictive model, the denoised population first neural response and the denoised population second neural response to create a centered unit vector for each of the denoised population first neural response and the denoised population second neural response; and
constructing a similarity matrix using the centered unit vector for each of the denoised population first neural response and the denoised population second neural response based on a representation similarity metric.

8. The method of claim 6, wherein the representation similarity metric is Sᵢⱼ^{model}=êᵢ·êⱼ for the first image and the second image, where eᵢ=(rᵢ−r)/(∥rᵢ−r∥) where r̅=Eᵢ[rᵢ] and eⱼ=(rⱼ−r)/(∥rⱼ−r∥) where r̅=Eⱼ[rⱼ].

9.-15. (canceled)

16. A method comprising:
accessing, by a computing system, a plurality of stimuli for a behavioral scheme;
inputting, by the computing system, a first stimulus of the plurality of stimuli into a behavioral predictive model;
generating, by the behavioral predictive model, a prediction of a first behavioral response of a biological system to the first stimulus;
scaling, by the behavioral predictive model, the predicted first behavioral response with a signal-to-noise weight to generate a predicted first behavioral response; and
providing, by the computing system, the predicted first behavioral response.

17. The method of claim 16, wherein the signal-to-noise weight (w_{α})=(signal strength σ²_{α})/(noise strength η²_{α}), where α is a given behavioral component of the biological system.

18. The method of claim 16, wherein the scaled predicted first behavioral response is defined as \hat{r}_{αi}=w_{α}v_{α}\hat{p}_{αi}, where (v_{α})=(signal strength σ²_{α})/(noise strength η²_{α}), α is a given behavioral component of the biological system and i is the first stimulus, and v_{α} is a correlation between an actual behavioral response of the biological system to the first stimulus and the predicted first behavioral response of the biological system.

19. The method of claim 16, wherein the behavioral predictive model is a convolutional neural network, the plurality of stimuli are a plurality of stimuli, triggers, and/or behavioral requests, and the first stimulus is a first behavioral request.

20. The method of claim 16, further comprising:
repeating the inputting of the first stimulus to generate, by the behavior predictive model, a plurality of predicted first behavioral responses for the first stimulus; and
generating, by the behavioral predictive model, a multi-system first behavioral response based on the plurality of predicted first behavioral responses, wherein the multi-system first behavioral response is a vector of the plurality of multi-system predicted first behavioral responses for the first stimulus.

21. A system comprising:
one or more processors; and
a memory coupled to the one or more processors, the memory storing a plurality of instructions executable by the one or more processors, the plurality of instructions comprising instructions that when executed by the one or more processors cause the one or more processors to perform the following operations:
accessing, by a computing system, a plurality of stimuli for a stimulus scheme;
inputting, by the computing system, a first stimulus of the plurality of stimuli into a neural predictive model;
generating, by the neural predictive model, a prediction of a first neural response of a biological system to the first stimulus;
scaling, by the neural predictive model, the predicted first neural response with a signal-to-noise weight to generate a denoised predicted first neural response; and
providing, by the computing system, the denoised predicted first neural response.

22. The system of claim 21, wherein the signal-to-noise weight (w_{α})=(signal strength σ²_{α})/(noise strength η²_{α}), where α is a given neuron of the biological system.

23. The system of claim 21, wherein the scaled predicted first neural response is defined as \hat{r}_{αi}=w_{α}v_{α}\hat{p}_{αi}, where (w_{α})=(signal strength σ²_{α})/(noise strength η²_{α}), α is a given neuron of the biological system and i is the first stimulus, and v_{α} is a correlation between an actual neural response of the biological system to the first stimulus and the predicted first neural response of the biological system.

24. The system of claim 21, wherein the neural predictive model is a convolutional neural network, the plurality of stimuli are a plurality of images, and the first stimulus is a first image.

25. The system of claim 21, wherein the operations further comprise:
repeating the inputting of the first stimulus to generate, by the neural predictive model, a plurality of denoised predicted first neural responses for the first stimulus; and
generating, by the neural predictive model, a denoised population first neural response based on the plurality of denoised predicted first neural responses, wherein the denoised population first neural response is a vector of the plurality of denoised predicted first neural responses for the first stimulus.

26. The system of claim 25, wherein the operations further comprise:
inputting, by the computing system, a second stimulus of the plurality of stimuli into the neural predictive model;
generating, by the neural predictive model, a prediction of a second neural response of the biological system to the second stimulus;
scaling, by the neural predictive model, the predicted second neural response with the signal-to-noise weight to generate a denoised predicted second neural response;
repeating the inputting of the second stimulus to generate, by the neural predictive model, a plurality of denoised predicted second neural responses for the second stimulus; and
generating, by the neural predictive model, a denoised population second neural response based on the plurality of denoised predicted second neural responses, wherein the denoised population second neural response is a vector of plurality of denoised predicted second neural responses for the second stimulus.

27. The system of claim 26, wherein the operations further comprise:
shifting and normalizing, by the neural predictive model, the denoised population first neural response and the denoised population second neural response to create a centered unit vector for each of the denoised population first neural response and the denoised population second neural response; and
constructing a similarity matrix using the centered unit vector for each of the denoised population first neural response and the denoised population second neural response based on a representation similarity metric,
wherein the representation similarity metric is Sᵢⱼ^{model}=êᵢ·êⱼ for the first image and the second image, where eᵢ=(rᵢ−r)/(∥rᵢ−r∥) where r̅=Eᵢ[rᵢ] and eⱼ=(rⱼ−r)/(∥rⱼ−r∥) where r̅=Eⱼ[rⱼ].
